(19) United States
(12) Patent Application Publication
(10) Pub. No.: US 2023/0206757 A1
(43) Pub. Date: Jun. 29, 2023

(54) VEHICLE CONTROL SYSTEM AND METHOD FOR MANAGING ADVERSE EVENTS

(71) Applicant: Westinghouse Air Brake Technologies Corporation, Pittsburgh, PA (US)

(72) Inventor: James A. Oswald, Coggon, IA (US)

(21) Appl. No.: 18/177,346

(22) Filed: Mar. 2, 2023

Related U.S. Application Data
(63) Continuation-in-part of application No. 16/722,827, filed on Dec. 20, 2019, now Pat. No. 11,605,248.

(51) Int. Cl. G08G 1/0965; G08G 1/09; B60W 10/18; B60W 10/20; B60W 10/04; B60W 60/00; G08G 1/0968; G01C 21/34; G01C 21/36

(52) U.S. Cl. CPC G08G 1/0965; G08G 1/091; B60W 10/18; B60W 10/20; B60W 10/04; B60W 60/0015; G08G 1/096816; G01C 21/3415; G01C 21/3492; G01C 21/3691; B60W 2556/50; B60W 2756/10; B60W 2420/42

(57) ABSTRACT

A system and method receive an event signal indicative of an adverse event on a vehicular pathway from one or more of a user interface device or one or more sensors disposed onboard the first vehicle. Event information is determined that is associated with the adverse event on the vehicular pathway and the first vehicle. An event alert is generated that contains the event information, and a communication device onboard the first vehicle is controller to communicate the event alert to an offboard control system configured to control movement of one or more second vehicles based on the event alert by modifying a respective planned route of each of the one or more second vehicles to bypass a location of the adverse event. The one or more second vehicles are not mechanically connected to the first vehicle and do not operate under control of the first vehicle.

### CROSS-REFERENCE TO RELATED APPLICATIONS

This application is a continuation-in-part of, and claims priority to, U.S. patent application Ser. No. 16/722,827, filed Dec. 20, 2019, which is incorporated by reference herein in its entirety.

### FIELD

The subject matter described herein relates to methods and systems for managing adverse events in a vehicle network.

### BACKGROUND

Collision avoidance is a feature implemented on or in association with a vehicle control system to allow vehicles on the network to move without colliding with other vehicles or obstacles. On many types of vehicle control networks, collision avoidance systems are important in reducing the number and severity of accidents, as well as saving lives. Upon the occurrence of an adverse event (e.g., a collision, a fouled pathway, a breakdown, or the like), it can be important for one or more vehicles involved in the event to communicate information related to the event. The prompt notification of the event to other vehicles in proximity of the event can prevent the involvement of additional vehicles in the event. However, the event may render one or more communication modalities onboard the vehicle(s) inoperable. Additionally or alternatively, crew onboard the vehicle(s) may be physically incapable of initiating a reporting function.

### BRIEF DESCRIPTION

In accordance with one or more embodiments described herein, a vehicle control system is provided that includes an onboard controller disposed onboard a first vehicle. The onboard controller may receive an event signal indicative of an adverse event on a vehicular pathway. The event signal may be received from one or more of a user interface device or one or more sensors disposed onboard the first vehicle. The onboard controller may determine event information associated with the adverse event on the vehicular pathway and the first vehicle, and generate an event alert that contains the event information. The onboard controller may control a communication device onboard the first vehicle to communicate the event alert to an offboard control system configured to control movement of one or more second vehicles based on the event alert by modifying a respective planned route of each of the one or more second vehicles to bypass a location of the adverse event. The one or more second vehicles are not mechanically connected to the first vehicle and do not operate under control of the first vehicle.

In accordance with one or more embodiments described herein, a method for managing adverse events is provided that includes receiving, via an onboard controller disposed onboard a first vehicle, an event signal indicative of an adverse event on a vehicular pathway. The event signal may be received from one or more of a user interface device or one or more sensors disposed onboard the first vehicle. The method may include determining event information associated with the adverse event on the vehicular pathway and the first vehicle, and generating an event alert that contains the event information. The method may include controlling a communication device onboard the first vehicle to communicate the event alert to an offboard control system configured to control movement of one or more second vehicles based on the event alert by modifying a respective planned route of each of the one or more second vehicles to bypass a location of the adverse event. The one or more second vehicles are not mechanically connected to the first vehicle and do not operate under control of the first vehicle.

In accordance with one or more embodiments described herein, a vehicle control system is provided that includes an onboard controller disposed onboard a first vehicle. The onboard controller may receive an event signal indicative of an adverse event on a vehicular pathway. The event signal may be received from one or more of a user interface device or one or more sensors disposed onboard the first vehicle. The onboard controller may obtain planned routes of other vehicles in a vehicle network with the first vehicle, and may determine one or more second vehicles of the other vehicles in the vehicle network that are affected by the adverse event based on a comparison between a location of the adverse event and the planned routes of the other vehicles, prior to the one or more second vehicles reaching the location of the adverse event. The one or more second vehicles are not mechanically connected to the first vehicle and do not operate under control of the first vehicle. The onboard controller may generate a respective event alert for each of the one or more second vehicles that are determined. The onboard controller may generate each respective event alert to include at least one of a re-route message or a control command message to modify the respective planned route of the corresponding second vehicle to cause the corresponding second vehicle to bypass the location of the adverse event. The onboard controller may control a communication device onboard the first vehicle to communicate the event alerts to the one or more second vehicles.

### BRIEF DESCRIPTION OF THE DRAWINGS

The present inventive subject matter will be better understood from reading the following description of non-limiting embodiments, with reference to the attached drawings, wherein below:

FIG. 1 illustrates an example of a vehicle control system for managing adverse alerts in accordance with one or more embodiments described herein;

FIG. 2 illustrates an example vehicle network for implementing the vehicle control system in accordance with one or more embodiments described herein;

FIG. 3 illustrates an example of a communications network for managing an adverse event in accordance with one or more embodiments described herein; and

FIG. 4 illustrates an example method for managing an adverse event in accordance with one or more embodiments described herein.

### DETAILED DESCRIPTION

One or more embodiments of the inventive subject matter described herein provide for systems and methods that are configured to detect and manage responses to adverse events involving vehicles along vehicular pathways. The systems and methods may manage by generating and communicating messages indicative of detected adverse events. The adverse events can be accidents (e.g., collisions), emergency brake situations, obstructions that block a pathway, a damaged section of pathway, or the like which impedes progress along a route. The messages are referred to herein as event alerts. An event alert can be generated by an onboard control unit (e.g., controller) disposed onboard a vehicle that travels through a vehicle network. The event alert may be communicated from a communication device onboard the same vehicle. The event alert can be generated in response to user-based instructions and/or analysis of output from one or more sensors. The systems and methods determine event information associated with the adverse event and the vehicle, and the event alert may be generated to include the event information. The event information can include sensed parameter data output from the one or more sensors and/or image data captured by one or more optical sensors operably coupled to the onboard controller.

The systems and methods according to one or more embodiments communicate the event alert containing the event information from the first vehicle (on which the event alert is generated) to one or more other vehicles operating in the same vehicle network, to one or more offboard control systems that control movement of the first vehicle and one or more other vehicles, or separately to both the first vehicle and the one or more other vehicles. The systems and methods improve communication of adverse events in vehicle networks by reporting events in a manner that reduces the risk or interference presented by the adverse event to other vehicles in the vehicle network. For example, rather than communicate an alert to a dispatch facility and wait for the dispatcher to issue a bulletin to other, nearby vehicles, the systems and methods described herein may more timely notify the other vehicles without waiting for a bulletin from a dispatcher. The first vehicle may directly communicate with the other vehicles to warn the other vehicles of the location and nature of the adverse event and/or may control movement of the other vehicles (e.g., directly or through a remote server) to avoid the location of the adverse event. Quicker notification of an adverse event may reduce the delays experienced by other vehicles due to the adverse event and may reduce the risk of the other vehicles being harmed by the adverse event. For example, another vehicle may be harmed by the adverse event if the other vehicle collides with a stopped vehicle or obstacle on the pathway. Additionally or alternatively, the systems and methods described herein may improve the emergency response to the adverse event itself by indicating the type and extent (e.g., severity) of the event so that appropriate levels and types of emergency responses can be deployed to the location of the adverse event.

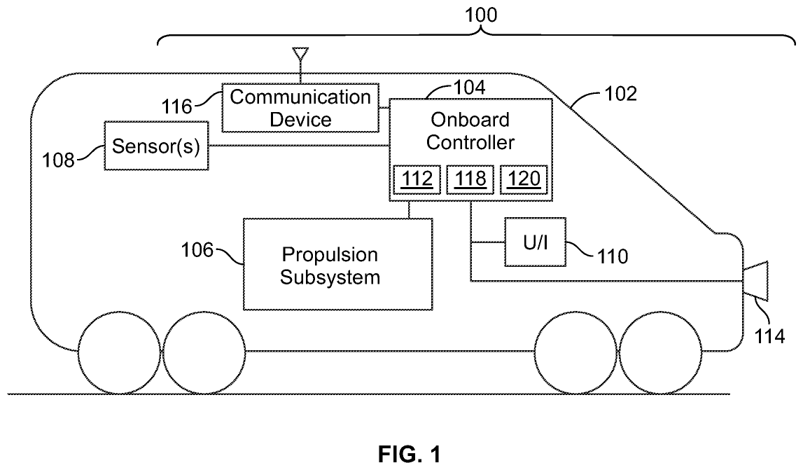

FIG. 1 illustrates an example of a vehicle control system 100 implemented onboard a vehicle 102 in accordance with one or more embodiments described herein. The term “vehicle” shall refer to any system for transporting or carrying one or more passengers and/or cargo. Types of vehicles 102 include automobiles, trucks, buses, rail vehicles (e.g., one or more locomotives and/or one or more rail cars), agricultural vehicles, mining vehicles, aircraft, industrial vehicles, marine vessels, automated and semi-automated vehicles, autonomous and semi-autonomous vehicles, and the like. The vehicle 102 can be a vehicle system that includes multiple vehicles logically and/or mechanically connected together to form a consist. The term “consist,” or “vehicle consist,” refers to two or more vehicles that are mechanically or logically coupled to each other. By logically coupled, the vehicles are controlled so that controls to move one of the vehicles causes a corresponding movement in the other vehicles in the same consist, such as by wireless command. An Ethernet over multiple unit (eMU) system may include, for example, a communication system for use transmitting data from one vehicle to another in the consist (e.g., an Ethernet network over which data is communicated between two or more vehicles). In one example of a consist, the vehicle 102 can be capable of propulsion to pull and/or push additional vehicles, either capable or incapable of propulsion, carrying passengers and/or cargo (e.g., a train or other system of vehicles). For example, a train consist may include one or more locomotives connected to one or more non-propulsion-generating rail cars. The vehicle 102 is referred to herein as a first vehicle. Although not shown, the vehicle 102 in FIG. 1 may be logically and/or mechanically connected to one or more other vehicles to define a first consist. Alternatively, the first vehicle 102 may be a single, unitary vehicle that is not part of a consist.

The vehicle 102 includes an onboard controller 104, one or more sensors 108, a propulsion subsystem 106, one or more sensors 108, a user interface device 110, one or more optical sensors 114, and a communication device 116. The sensor(s) 108, propulsion subsystem 106, user interface device 110, optical sensor(s) 114, and the communication device 116 may be communicatively connected to the onboard controller 104 via wired communication pathways and/or wireless communication pathways. The onboard controller 104 can control operation of the vehicle 102. For example, the onboard controller 104 may generate and communicate control signals to the various components via the wired and/or wireless communication pathways for controlling operation of the various components. Optionally, in the case of a consist where the first vehicle 102 is the lead vehicle, the onboard controller 104 can be configured to provide control signals to other vehicles in the consist to control the tractive efforts and/or braking efforts of the other vehicles in the consist.

The propulsion subsystem 106 may include a powertrain for delivering tractive effort to wheels, axles, propellers, and/or the like, to propel the vehicle 102 along a route. The propulsion subsystem may include one or more motors, fuel-combustion engines, batteries, fuel cells, and/or the like. The components of the propulsion subsystem may be communicatively connected to the onboard controller and controlled by the onboard controller. The propulsion system may also include brake components for slowing movement of the vehicle and/or maintaining the vehicle in a stationary position. The brake components may include a friction brake system, a regenerative (e.g., dynamic) brake system, and/or the like. The onboard controller can control the propulsion subsystem to exert tractive efforts and braking efforts at different times and locations along the vehicle network to control the movement of the vehicle. For example, the onboard controller may instruct the propulsion system to implement different tractive settings at different times to vary the amount of propulsion provided by the vehicle.

In accordance with one or more embodiments described herein, the onboard controller 104 can include and/or implement a control system 120 (e.g., a positive train control system or other system including positive control functionality). The control system 120 may monitor the location and movement of the vehicle 102 within a vehicle network of pathways (e.g., routes). For example, the control system can enforce travel restrictions including movement authorities that prevent unwarranted movement of the vehicle 102 into certain route segments. Additionally or alternatively, the control system can allow the vehicle to enter certain route segments unless or until a signal from an offboard control system instructs the vehicle 102 to not enter the segment.

Based on travel information generated by the vehicle network and/or received through the communication device 116, the control system can determine the location of the vehicle 102, how fast the vehicle can travel based on the travel restrictions, and, if movement enforcement is performed, to adjust the speed of the vehicle 102. The travel information can include features of the pathways (e.g., railroad tracks, shipping lanes, roads, or the like), such as geometry, grade, currents (e.g., water currents, electrical currents, and the like), etc. Also, the travel information can include travel restriction information, such as movement authorities and speed limits, which can be dependent on a vehicle network zone and/or a pathway. The travel restriction information can also account for vehicle state information (e.g., length, weight, height, etc.). In this way, vehicle collisions, over speed accidents, incursions into work zones, and/or travel through improperly managed junctions among pathways can be reduced or prevented. As an example, the control system may provide commands to the propulsion system of the vehicle 102 and, optionally, to propulsion systems of one or more additional trailing vehicles in a consist, to slow or stop the vehicle 102 or consist in order to comply with a speed restriction or a movement authority. It will be appreciated that the onboard controller 104 may also implement, in addition to or in lieu of positive controls, one or more of negative controls, open loop controls, closed loop controls, or the like without departing from the scope of the inventive subject matter discussed herein.

The onboard controller 104 represents hardware circuitry that may include and/or is connected with one or more processors 112 (e.g., one or more microprocessors, integrated circuits, microcontrollers, field programmable gate arrays, etc.) or other electronic logic-based devices. The onboard controller may include and/or is connected with a tangible and non-transitory computer-readable storage medium 118 (e.g., data storage device), which is referred to herein as memory. The memory 118 stores program instructions (e.g., software) that are executed by the one or more processors to perform the controller operations described herein. For example, the memory 118 may include instructions that, when executed by the processor(s) 112, perform operations for managing adverse events in a vehicle network. The operations may include receiving event signals, confirming an adverse event, determining event information associated with the adverse event, generating an event alert that includes at least some of the event information, and communicating the event alert to one or more other vehicles and/or one or more offboard control systems. The one or more other vehicles that receive the event alert may be operating (e.g., traveling) within a designated range of the first vehicle 102. The one or more offboard control systems can be configured to control movement of at least the vehicle 102 and one or more other vehicles, as described herein.

The communication device 116 represents hardware circuitry that can communicate electrical signals via wireless communication pathways and/or wired conductive pathways. The communication device may include transceiving circuitry, one or more antennas, and the like, for wireless communication. The communication device 116 may be controlled by the onboard controller to communicate, among other things, event alerts over different communication paths in accordance with one or more embodiments described herein. The one or more processors 112 may select one or more different communication paths for managing an event alert or may communicate the event alert via all available and/or operational communication paths. For example, the controller 104 may include a subset of types of transceivers (e.g., wireless network transceivers) while communication device includes a different subset of types of transceivers (e.g., radio frequency transceivers and/or wireless network transceivers). It will be appreciated that additional transceivers for different communication paths may be provided or that one or more of the communications pathways discussed above may be omitted without departing from the scope of the inventive subject matter discussed herein.

The sensor(s) 108 can include speed sensors (e.g., Hall effect sensors or the like), accelerometers, pressure sensors, humidity and/or temperature sensors (e.g., thermopiles, thermocouples, thermistors, and the like), position sensors (e.g., linear position and/or angular position sensors), level sensors, chemical sensors, optical sensors, or the like. The sensor(s) 108 can be configured to measure various properties including, but not limited to, one or more of speed, acceleration, position, orientation, vibration, pressure, temperature, humidity, and/or liquid level.

The optical sensor(s) 114 may include one or more cameras. At least one of the cameras may be forward facing such that the camera is oriented towards the space in front of the vehicle 102. The optical sensor(s) 114 may also include cameras oriented to face other directions and/or features of interest. Additionally or alternatively, one or more optical sensors 114 may be disposed inside the vehicle 102. For example, the vehicle 102 may include a cab camera disposed inside a cab of the vehicle 102. The optical sensors 114 can generate static (e.g., still) images and/or dynamic images (e.g., video) as image data. The optical sensor(s) 114 may be controlled to continuously or intermittently record image data. Alternatively, the optical sensor(s) may be controlled to record image data in response to receiving a control signal generated by the one or more processors 112. The processor(s) may control the optical sensor(s) to begin recording image data in response to receiving an event signal indicative of an adverse event on a vehicular pathway.

The user interface (U/I) device 110 allows a human operator to interact with the onboard controller 104 by submitting user inputs. The U/I device may include one or more input devices designed to generate user command signals based on user manipulations (e.g., selections) provided on the input device(s). For example, an input device may include or represent a touch sensitive screen or pad, a mouse, a keyboard, a joystick, a switch, a microphone, physical buttons, and/or the like. In an embodiment, the U/I device may include a physical button or a virtual button in a graphical user interface (GUI) that is specifically associated with adverse event detection. For example, upon an operator seeing, hearing, and/or otherwise physically detecting an adverse condition on a vehicle pathway, the operator may press the button. Upon receiving the user selection, the U/I device may communicate an event signal to the onboard controller 104 indicating that the operator has selected the adverse event button. The controller may respond to the event signal from the U/I device as described herein. The U/I device 110 may enable an operator to provide additional information, such as a type or category of the adverse event that is detected. For example, the operator may select that the adverse event is a rollover accident, a collision between multiple vehicles, a stalled vehicle, a non-vehicle obstacle blocking the pathway, or the like.

The U/I device may include a display device having a display screen that presents graphical indicia, such as text and symbols, for viewing by the operator. The onboard controller may display a message on the screen of the display device to provide information to the operator. Optionally, the U/I device may include an audio speaker, one or more signal lights, and/or the like, for notifying and/or conveying information to the operator.

The onboard controller 104 may receive an event signal indicative of an adverse event. The event signal may be generated by the sensor(s) 108, the optical sensor(s) 114, the U/I device 110, or a message received by the communication device 116 from off-board the vehicle 102. As described above, one type of event signal can be generated by the U/I device 110 in response to a user-based selection, such as a touch input, a voice command input, or the like. For example, upon experiencing an adverse event, a crew member onboard the vehicle 102 may access U/I 110 and select the button to generate an event signal. Additionally or alternatively, the operator may access a user interface device that is implemented on a personal computing device (e.g., smartphone, wearable computer, tablet computer, laptop computer, etc.), rather than the onboard U/I device 110, to generate an event signal.

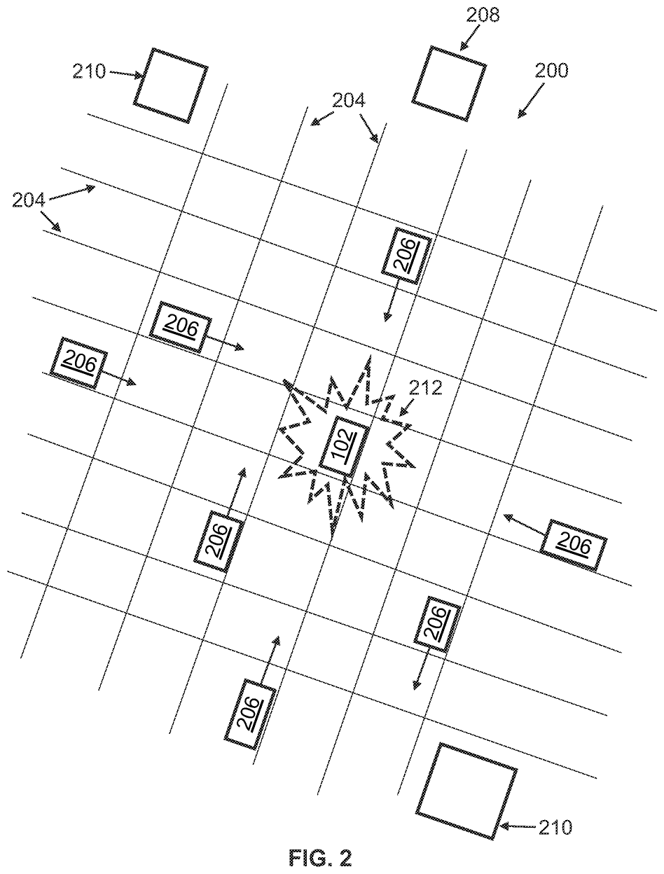

Additionally or alternatively, in accordance with one or more embodiments described herein, the event signal can be generated based on a value of a sensed parameter by the one or more sensors 108 of the vehicle 102 and/or another vehicle 206 passing by the site of the adverse event 212 as shown in FIG. 2. For example, the event signal can be generated in response to detecting one or more values of speed, position, orientation, vibration, pressure, humidity, or liquid level that meet predetermined criteria for generating an event signal. Examples of predetermined criteria for generating an event signal can include one or more values that fall outside a select range, that fall below or exceed a threshold value, or that do not otherwise occur during normal operation of the vehicle 102.

In an example, an accelerometer of the sensor(s) 108 may detect an abrupt acceleration change that is exceeds a range of acceleration values expected to be experienced during normal operation conditions of the vehicle 102. The abrupt acceleration change may be attributable to an emergency brake application, a collision of the vehicle 102 with another vehicle or large obstacle in the vehicular pathway, or the like. The onboard controller 104 may receive measured acceleration values from the accelerometer. A measured acceleration value that exceeds a designated threshold acceleration value (e.g., is outside of a designated range of expected acceleration values) may be classified by the onboard controller 104 as an event signal at least potentially indicative of an adverse event on the pathway. In another example, the accelerometer or another one of the sensor 108 may be able to monitor the orientation of the vehicle 102. The sensed parameter values generated by such sensor may represent an orientation of the vehicle 102 over time. The onboard controller 104 may receive and analyze the orientation values over time. Orientation values that indicate that the vehicle 102 experienced a substantial orientation change may be classified by the onboard controller 104 as an event signal. For example, the substantial orientation change may occur if the vehicle 102 tips over, rolls, spins, or the like, which may occur in an accident (e.g., collision, derailment, etc.).

Additionally or alternatively, in accordance with one or more embodiments described herein, the event signal can be generated based on image analysis of image data generated by the one or more optical sensors 114. For example, the one or more processors 112 of the onboard controller 104 may receive the image data generated by the optical sensor(s) 114 over time, and may perform image analysis on the image data. The image analysis may seek predetermined characteristics depicted in the image data which are associated with adverse events on the vehicular pathway. In one aspect, the one or more processors 112 can examine the image data by identifying benchmark features (e.g., rails of a track, a horizon, edges of a street, the shape of a vehicle, etc.) in the image data, and comparing the location and orientation of the benchmark features to each other and/or to known reference positions of the benchmark features. For example, if the horizon is oriented vertically rather than horizontally in the image data, then the vehicle 102 is on its side. In another example, if the benchmark features in the image data include a vehicle that is determined to be stationary and oriented at an oblique angle that extends across the vehicular pathway, then the onboard controller 104 can interpret the image data as an event signal indicative of an adverse event. Furthermore, the onboard controller 104 may compare the image data obtained from the optical sensor(s) 114 to reference sets of image data depicting different types of adverse event conditions (e.g., stalled vehicles, rollover, derailment, collision, obstacle in pathway, etc.). The reference sets may be stored in the memory 118. If the image data received from the optical sensor(s) 114 matches one of the reference sets beyond a similarity threshold, then the controller 104 may classify the received image data as an event signal indicative of an adverse event. The controller 104 may also determine the type of adverse event based on which reference image data best matches the received image data. In a similar way, the onboard controller 104 may be configured to determine the type of adverse event based on sensed parameters generated by the non-optical sensors 108. For example, different types of adverse events may have different sensed parameters that are characteristic of that specific type of adverse event.

In response to receiving the event signal, the one or more processors 112 of the onboard controller 104 may determine event information associated with the adverse event and the vehicle 102. The event information can include sensed parameter data output from the one or more sensors 108, image data output from the one or more optical sensors 114, location data indicative of the location of the detected adverse event, vehicle information identifying, if possible, one or more vehicles involved in the adverse event, and/or event details describing the nature and/or severity of the adverse event. The event information can include a vehicle identification, a vehicle location, and/or vehicle consist information.

The event details of the event information may include a medical attention indicator, a vehicle count indicator, and/or a hazardous condition indicator. The medical attention indicator can provide a requested medical response. For example, the medical attention indicator could indicate a requested medical response that is appropriate based on a number of potentially injured passengers. For example, if the vehicle involved in the adverse condition is a passenger train, the medical attention indicator may request paramedics. The medical attention indicator may also indicate the number of passengers that may need medical attention, which enables emergency services to send an appropriate number of paramedics to treat those that are potentially injured. The vehicle count indicator can be indicative of a number of vehicles associated with the event. For example, based on a collision between multiple vehicles or based on an event affecting one or more vehicles of a consist, the vehicle count indicator can transmit a number or estimated number of vehicles involved in and/or affected by the event. The hazardous condition indicator can indicate a requested hazardous condition response based on a type of cargo carried by the vehicle that is potentially spilled on the pathway. For example, if the vehicle involved in the adverse condition is carrying a cargo that may be spilled on the pathway, the hazardous condition indicator may identify the type of cargo, the amount of cargo, and the like, to enable emergency services to send appropriate equipment to clean the spilled cargo and limit secondary damage or harm from the spilled cargo. If the cargo is a hazardous substance, the hazardous condition indicator can notify relevant authorities and/or emergency responders of the hazardous substance.

Upon receipt of an event signal, particularly an event signal that indicates a vehicle accident/collision, the onboard controller may access stored vehicle information about the vehicle involved in the adverse event. The onboard controller may determine, based on the stored vehicle information, that the vehicle is carrying a hazardous substance. In response to determining that the vehicle is carrying the hazardous substance, the onboard controller may determine the relevant authorities and/or emergency responders appropriate for addressing the hazardous substance. In an example, the memory 118 may have program instructions that identify the hazardous substance onboard and provide a list of one or more agencies to contact in the event of a spill of the hazardous substance. The onboard controller may include this hazardous condition indicator in an event alert generated by the onboard controller to be remotely communicated. Furthermore, the onboard controller may determine which recipient(s) to send the event alert based on the medical attention indicator and/or the hazardous event indicator. For example, if the medical attention indicator provides that no medical attention is necessary, then the onboard controller may not transmit the event alert to medical personnel (e.g., paramedics, 911, etc.). Furthermore, if the hazardous event indicator provides that a hazardous substance may be spilled on the pathway, then the onboard controller may transmit the event alert to the Environmental Protection Agency, a hazardous waste management company, a local Police authority, and/or the like.

In an example, the one or more processors 112 of the onboard controller 104 may confirm the adverse event prior to generating and communicating an event alert. Confirmation of an adverse event can take place before, after, or as part of determining the event information. Confirming an adverse event may reduce the likelihood of false positive adverse events, which may be caused, for example, by a malfunctioning sensor 108 and/or mis-analyzed image data. The one or more processors 112 can confirm the adverse event by obtaining a confirmation signal. In an example, the confirmation signal may be received from the user interface device 110, which receives a user input from an operator (e.g., crew member). For example, upon receiving the event signal indicative of an adverse event, the one or more processors 112 may generate a request for confirmation message. The confirmation request message may be presented on the user interface device 110 and/or communicated to a personal mobile computer device carried by an operator. The confirmation request message may be displayed on a display of the user interface device 110 and/or the personal mobile computer device. Upon receiving the confirmation request message, the operator may use the operator's own senses to determine whether an adverse event is present on the pathway. The operator may provide confirmation of the adverse event, in response to receiving the confirmation request message, by selecting a button (e.g., physical or virtual on a GUI) or providing a voice-based confirmation.

Additionally or alternatively, the one or more processors 112 can confirm the adverse event by obtaining additional and/or different (e.g., in time or location) values of one or more sensed parameters from the one or more sensors 108 and/or the one or more optical sensors 114. Examples of sensed parameter values for confirming an event signal can include one or more values that fall outside a select range, that fall below or exceed a threshold value, or that do not otherwise occur during normal operation of the vehicle 102. For example, based on receiving an event signal manually generated by an operator (e.g., a crew) using the user interface device 110, the one or more processors 112 may confirm the adverse event by obtaining acceleration values indicative of a sudden stop, orientation values/signatures of the vehicle 102 indicative of a non-operational orientation of the vehicle 102, temperature values exceeding or falling below normal environmental and/or operational values, and the like. In another example, the one or more processors 112 may confirm an adverse event, based on a manually-input event signal, by obtaining and examining image data captured by the one or more optical sensors 114. For example, the one or more processors 112 can confirm the adverse event if the image data indicates that the vehicle is no longer in an operational orientation, that a stationary vehicle in an unexpected position is blocking the pathway, and/or the like, as described above. Thus, the onboard controller 104 may require at least two independent forms of event signals to confirm the adverse event. The independent forms may include operator (e.g., manual) input, a first type of sensor 108 (e.g., accelerometer), a second type of sensor 108 (e.g., temperature sensor) that is different from the first type of sensor, and/or the optical sensor 114.

In response to confirming the adverse event, the one or more processors 112 may generate an event alert that includes the event information. On the other hand, if the adverse event is not confirmed, the one or more processors may not generate the event alert. For example, if the operator indicates via the user interface device 110 in response to a confirmation request message that no adverse event is present, the onboard controller may not generate or communicate any event alert. In an alternative embodiment in which the onboard controller does not request confirmation, the onboard controller may generate the event alert in response to receiving the event signal. The event information contained in the event alert may be selected to support quickly remedying the adverse event. For example, the event information within the event alert may include a location of the adverse event in the vehicle network, an indication of the type of adverse event, the vehicle count indicator, the medical attention indicator, the hazardous condition indicator (or other indication of cargo), a time at which the event alert was generated, and/or the like. The type of adverse event may refer to a collision between two or more vehicles, a single vehicle accident, a spilled substance on the pathway, a stalled vehicle, an obstacle across the pathway, and/or the like.

Upon generating the event alert, the onboard controller may communicate the event alert to one or more other vehicles operating in the vehicle network and/or to one or more offboard control systems. The onboard controller may communicate the event alert by controlling the communication device 116 to transmit the event alert. For example, the communication device 116 may be controlled to wirelessly communicate the event alert. In an embodiment, an offboard control system may be configured to control movement of the vehicle 102 and other vehicles based on the event alert. In one example, the offboard control system may control the movement of the vehicles by automatically re-routing the scheduled trips of the vehicles to avoid the adverse event location. In another example, the vehicles in the vehicle network may be remotely controlled by the offboard control system. The offboard control system may control the movement of the vehicles by transmitting control messages that designate steering settings, tractive settings, and/or brake settings. The settings are automatically implemented by the vehicles upon receipt to cause the vehicles to avoid the adverse event location.

FIG. 2 illustrates an example vehicle network 200 on which the vehicle control system 100 can be implemented in accordance with one or more embodiments described herein. The vehicle network includes multiple vehicles 102, 206, a network of pathways 204 (e.g., routes) along which the vehicles 102, 206 travel, and/or one or more offboard control systems 208. The vehicle network 200 may be capable of communicating and/or implementing one or more of positive controls, negative controls, open loop controls, closed loop controls, or the like. The vehicle network 200 may exist in a static or dynamic geographic domain or among a select vehicle population. The vehicle network 200 may be formed on an ad-hoc basis between a plurality of vehicles 102, 206.

The vehicles shown in FIG. 2 include the first vehicle 102 and multiple second vehicles 206. The first vehicle 102 is the vehicle that includes the onboard controller 104 shown in FIG. 1. Although indicated by different reference numbers, the first vehicle 102 may be the same type of vehicle as one or more of the other (e.g., second) vehicles 206. For example, all of the vehicles 206 may have similar components of the vehicle 102 shown in FIG. 1, such as an onboard controller, a communication device, non-optical sensor(s), optical sensor(s), user interface device, propulsion subsystem, and/or the like. In an example, all of the vehicles 102, 206 are trains. In another example, all of the vehicles 102, 206 may be cars, transit vehicles, mining trucks, and/or the like. Each of the vehicles 102, 206 shown in FIG. 2 is a discrete vehicle system (e.g., vehicle, consist, etc.) that independently travels through the vehicle network 200. For example, the different vehicles 102, 206 are not mechanically connected to one another and do not operate under control of another vehicle. In an example, the different vehicles 102, 206 travel through the network 200 according to different, corresponding trip schedules.

The vehicle network 200 includes a plurality of pathways 204 (e.g., routes) along which the vehicles 102, 206 travel. The pathways 204 may be paved roads, unpaved roads, railroad tracks, and/or the like, regardless of any entity responsible for maintenance of the way (e.g., a private entity, a state entity, a provincial entity, a county entity, an international entity, or the like). The onboard controller 104 of the vehicle 102 can communicate the event alert containing the event information to one or more of the other vehicles 206 operating in the vehicle network 200. For example, the onboard controller 104 may send the event alert to other vehicles 206 that are within a designated range of the vehicle 102 and/or of the adverse event location. The designated range may be a predetermined distance value, such as a one mile radius. Alternatively, the designated range may be defined by a communication range, such as the permissible range of a wireless network associated with the vehicle network 200. The onboard controller 104 may separately communicate the event alert to the one or more offboard control systems 208.

The one or more offboard control systems 208 are off-board the vehicles 102, 206. The one or more offboard control systems 208 may include a dispatch facility (including a dispatcher), a remote server (e.g., back office system (BOS) server) or the like. In one example, the one or more offboard control systems 208 provide travel information to the vehicles 102, 206 operating in the vehicle network 200. Only one offboard control system 208 is illustrated in FIG. 2, although the vehicle network 200 may include multiple offboard control systems 208. In an example, the vehicle network 200 may include one or more wayside devices 210 along the pathways 204. The wayside devices 210 may include signaling devices, switching devices, communication devices, and/or the like. The wayside devices 210 may provide wireless access points that enable appropriately-equipped vehicles 102, 206 in range of the wayside devices 210 to connect to one or more communication networks associated with the vehicle network 200. The communication networks may include radio networks, wireless (e.g., Wi-Fi) networks, satellite networks, and/or the like. The communication device 116 onboard the vehicle 102 can dynamically establish a network session with available communication networks through such wayside devices 210 to relay information with the other vehicles 206 and/or the offboard control system 208. For example, the onboard controller 104 may use the communication device 116 to communicate the event alert to both the other vehicles 206 and the offboard control system 208 via the communication network.

FIG. 2 shows that the first vehicle 102 is involved in an adverse event 212. Upon the occurrence of the adverse event 212, the one or more processors 112 onboard the vehicle 102 receive the event signal. The event signal may be generated by a crew member accessing the user interface device 110 and selecting an event reporting function at the user interface device 110. Additionally or alternatively, the event signal may be automatically generated by the onboard controller 104 in response to sensed parameters indicative of the adverse event generated by the one or more sensors 108 and/or in response to analysis of image data captured by the optical sensor(s) 114 Based on the sensed parameters and/or the analysis of the image data, the onboard controller 104 may automatically generate the event signal regardless of the availability of the crew. The onboard controller 104 may confirm the existence of the adverse event 212 by generating a request for user confirmation and/or confirming the event 212 based on sensed parameters. Upon confirming the adverse event 212, the onboard controller 104 may determine event information associated with the event 212. For example, the event information can include one or more of sensed parameter data output from one or more sensors 108, image data captured by one or more optical sensors 114, a medical attention indicator, a vehicle count indicator, a hazardous condition indicator, a vehicle identification, a vehicle location, or vehicle consist information. The onboard controller 104 generates an event alert that includes at least some of the event information. The onboard controller 104 controls the communication device 116 to communicate the event alert to at least some of the other vehicles 206 in the network 200 and/or to the offboard control system 208. The event alert facilitates prompt notification of the event information to the onboard controllers of other vehicles 206 within a predetermined range of the adverse event 212. The event alert may also promptly notify dispatchers associated with the vehicle network 200, emergency responders, and/or other interested parties.

In an embodiment, the onboard controller 104 may indirectly communicate the event alert from the vehicle 102 to the one or more other vehicles 206 via the offboard control system 208. For example, the offboard control system 208 may be a BOS server that operates as a function of a control system (e.g., a PTC system). The offboard control system 208 may receive the event alert and automatically forward the event alert to the other vehicles 206 in range of the adverse event 212. In another embodiment, the onboard controller 104 may use the communication device 116 to directly communicate the event alert to the other vehicles 206 via a communication network, a radio transmission, or the like.

In an embodiment, upon receiving the event alert, the offboard control system 208 may control movements of one or more of the other (e.g., second) vehicles 206 in the vehicle network 200. The offboard control system 208 may control the movements of the other vehicles 206 by modifying (e.g., changing) planned routes of the vehicles 206 to bypass the location of the adverse event 212. Each planned routes includes a series of pathways 204 to be traversed by a corresponding one of the second vehicles 206 according to a scheduled trip assigned to that second vehicle 206. In various embodiments, the offboard control system 208 may change the planned routes by generating and communicating re-route messages and/or control command messages to the vehicles 206.

Prior to changing the planned routes, the offboard control system 208 may communicate with the vehicles 102, 206 in the vehicle network 200 in order to track the locations of the vehicles 102, 206. For example, the vehicles 102, 206 may periodically transmit location information of the respective vehicles 102, 206 to the offboard control system 208. The location information may include GPS coordinates, mile marker values, or the like. The offboard control system 208 may have access to trip schedules of each of the vehicles 102, 206 traveling in the network 200. Each trip schedule may include a date and/or time of the trip, a departure location, a destination location, and a series of pathways 204 to traverse from the departure location to the arrival location. The offboard control system 208, upon receipt of the event alert, may compare the location of the adverse event 212 to the current locations and scheduled routes of the vehicles 206 in the network 200 to determine which vehicles 200 potentially interfere with the adverse event 212 and/or the first responders attempting to reach the adverse event 212. In an example, the offboard control system 208 may identify any vehicles 206 that are currently within a designated proximity range of the adverse event location, and that are scheduled to enter the proximity range within a designated time period of receiving the event alert. The offboard control system 208 may actively modify the movements of those vehicles 206 that are identified.

In one example, the offboard control system may transmit specific re-route messages to the different vehicles that are currently scheduled to travel near or through the adverse event location within a period of time (e.g., one hour, two hours, or the like). The re-route messages may include detour navigation details specific for the recipient vehicle. The detour navigation details may alter the series of pathways 204 of the trip schedule specific to the recipient vehicle 206 to avoid the area of the pathway(s) 204 that includes the adverse event 212. For example, if the adverse event 212 is located along a first pathway 204, and the trip schedule of a given vehicle 206 designates that the vehicle 206 will traverse the first pathway 204 within a designated time period from the detection of the adverse event 212, then the offboard control system 208 may generate and transmit a re-route message to that vehicle 206. The re-route message includes detour navigation details that instruct the vehicle 206 to avoid or turn off the first pathway 204 prior to reaching the adverse event location. For example, the detour navigation details may instruct the vehicle 206 to turn onto a second pathway 204 and then onto a third pathway 204 to bypass the adverse event location, before turning back onto the first pathway 204 to continue traveling towards the destination location according to the trip schedule.

In an embodiment, upon receipt of the re-route message, the vehicle 206 may automatically update an onboard navigation system to include the detour navigation details. For example, a turn-by-turn navigation system may automatically instruct the operator of the vehicle to turn off the first pathway to the second pathway to bypass the adverse event 212. In another example, the onboard controller of the vehicle 206 may automatically implement the detour navigation details without requiring manual intervention. For example, the onboard controller may automatically steer onto the second pathway to bypass the adverse event 212.

In another example, the offboard control system 208 may automatically remotely control the movement of the vehicles 102, 206 along the pathways 204 by communicating control command messages to the vehicles 102, 206. For example, in response to receiving the event alert, the offboard control system 208 may generate the control command messages that are sent to the vehicles 206 that are scheduled to travel near or through the adverse event location within a period of time (e.g., one hour, two hours, or the like) of the event alert. The control command messages may be signals that represent steering settings, tractive settings and/or brake settings. The settings in the control command messages may be selected by the offboard control system 208 to cause the vehicles 206 to avoid the adverse event 212, which avoids delays experienced by those vehicles 206 and also avoids obstructing the path for first responder vehicles to approach the adverse event 212. Upon receiving the control command messages, the vehicle controllers of the vehicles 206 may automatically implement the steering settings, tractive settings, and brake settings of the control commands. For example, the settings may be forwarded as control signals to a steering system and the propulsion subsystem of the vehicle 206, and the steering system and propulsion subsystem may operate according to the received settings from the control command messages. In this embodiment, the vehicles 206 may lack a crew, or the crew may be functioning in merely a supervisory role in the vehicles' trips. In an example, a control command message sent to one of the vehicles 206 may include steering settings and tractive and brake settings that, when automatically implemented by the recipient vehicle 206, cause that vehicle 206 to deviate from the scheduled trip route by turning onto one or more different pathways 204 to bypass the adverse event 212 before rejoining the scheduled trip route at a location past the adverse event 212. The offboard control system 208 may know the scheduled trips and the current locations of each of the vehicles 102, 206 in the network 200, as described above, so the offboard control system 208 may generate a different control command messages for each of the vehicles 206 that would be affected by the adverse event 212. In another example, the control command message communicated to one vehicle 206 may cause the vehicle 206 to pull off of a pathway 204 onto a side pathway and stop on the side pathway for a designated amount of time to allow for first responders to pass by the vehicle 206 and/or to wait until the adverse event 212 is remedied.

These embodiments in which the offboard control system controls the movement of the vehicles 206 in the network 200 to avoid the adverse event 212 may be more efficient than known procedures that rely on manual intervention by a dispatcher. Furthermore, the re-route messages and the control command messages generated by the offboard control system may provide more timely and more effective avoidance of the adverse event than merely transmitting a network-wide bulletin indicating the location of the adverse event 212. For example, the offboard control system 208 may factor in additional details when generating the re-route messages and the control command messages than simply the location of the adverse event 212. Such additional details may include the routes expected to be traversed by first responder vehicles when traveling towards the adverse event 212. For example, if paramedics are required, the offboard control system 208 may generate the re-route messages and/or the control command messages to avoid a specific pathway 204 or series of pathways 204 from the paramedic source (e.g., fire station, etc.) to the location of the adverse event 212, thereby avoiding an issue in which the vehicles 206 obstruct the paramedics traveling to the adverse event 212.

In an alternative embodiment, the onboard controller 104 may perform the functions of the offboard control system 208 described above. For example, the onboard controller 104 may generate different event alerts to send to different vehicles 206 in the network 200, and each event alert may include a re-route message or a control command message, as described above, to modify the recipient vehicle's 206 movement to automatically bypass the location of the adverse event 212.

In an embodiment, the onboard controller 104 of the vehicle 102 may automatically communicate the event alert to multiple different recipients rather than send the event alert to one recipient, such as a dispatch facility. For example, the onboard controller 104 may communicate the event alert to the offboard control system 208 and to one or more other vehicles 206 in the network 200 that may be affected by the adverse event. In a first example, the onboard controller 104 may communicate the event alert to a subset of vehicles 206 within a designated proximity range of the adverse event location by broadcasting the event alert as a bulletin via a radio network. For example, the communication device 116 may broadcast a radio message including the event alert, and all vehicles 206 within the radio transmission range of the first vehicle 102 may receive the radio message. In another example, the onboard controller 104 may communicate the event alert to all vehicles 206 that are connected to a local wireless (e.g., mesh) network via the wayside devices 210 that function as wireless access points to the wireless network. In a third example, the first vehicle 102 may receive the current locations and scheduled routes of other vehicles 206 in the network 200, and may determine to which vehicles 206 to directly send the event alert based on a comparison of the adverse event location to the current locations and scheduled routes. The first vehicle 102 may receive the current locations and scheduled routes from the offboard control system 208 and/or directly from the other vehicles 206. Once the onboard controller 104 of the first vehicle 102 determines which vehicles 206 would be affected by the adverse event 212, the onboard controller 104 may use the communication device 116 to transmit the event alert wirelessly to those vehicles 206 that would be affected. Communicating the event alert to multiple parties may reduce the risk of secondary damage from the adverse event by quickly notifying other vehicles and quickly notifying a remote control system in parallel, rather than in series.

In an embodiment, the onboard controller 104 may determine the type of adverse event 212 based on a user input (e.g., via the user interface device 110), image data generated by the optical sensor(s) 114, and/or measured parameters generated by the sensor(s) 108. For example, the onboard controller 104 may use the input information to classify an adverse event 212 as a rollover accident, a collision between multiple vehicles, a stalled vehicle, an obstacle blocking the pathway 204 (e.g., a downed tree, telephone pole, light post, flooded pathway, etc.), The onboard controller 104 may generate the event alert to include the type of the adverse event 212.

Furthermore, the onboard controller 104 may select which additional parties (e.g., first responders) to send the event alert based on the type of adverse event 212 and/or the type of the first vehicle 102 that is involved in the adverse event 212, if applicable. For example, in response to determining that the adverse event 212 is a rollover accident and/or derailment of the first vehicle 102, or a collision between the first vehicle 102 and another vehicle, the onboard controller 104 may send the event alert to the other vehicles 206 that may be affected (e.g., may be in range), to the offboard control system 208, and to medical emergency first responders such as paramedics to assist with injured passengers and/or crew members. In another example, if the type of adverse event 212 is determined to be a stalled vehicle, the onboard controller 104 may communicate the event alert to the other vehicles 206 that may be affected, to the offboard control system 208, and to a roadside vehicle maintenance crew. In a third example, if the type of adverse event 212 is determined to be an obstacle blocking the pathway 212, the onboard controller 104 may communicate the event alert to the other vehicles 206 that may be affected, to the offboard control system 208, and to a route maintenance crew. The onboard controller 104 may access a look-up table or database in the memory 118 which provides a list of different types of adverse events 212 and corresponding contact information for one or more first responder parties appropriate for handling each type of adverse event 212.

In other examples, a dispatcher of the offboard control system 208 can review the image data transmitted as part of the event information in the event alert to allow instant assessment of the nature and severity of the event.

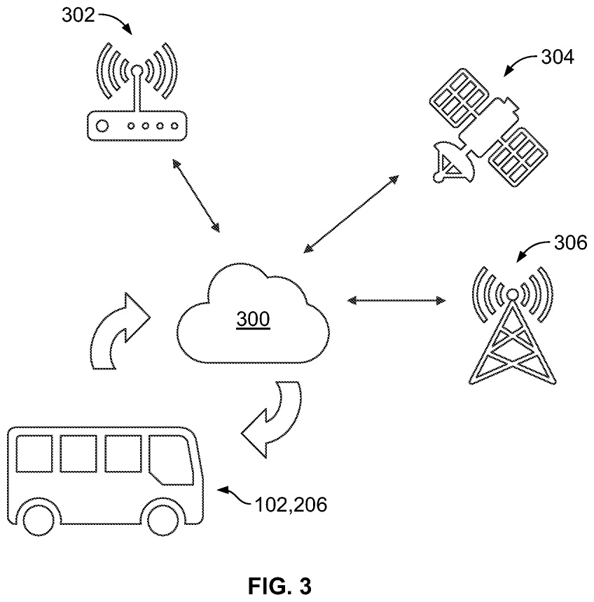

FIG. 3 illustrates a block diagram of an example of a communications network 300 for managing an adverse event 212 in accordance with one or more embodiments described herein. The communications network 300 can include a wireless network 302, a satellite network 304, and/or a radio network 306. The vehicles 102, 206 on the vehicle network 200 can include, as part of the communication device 116, one or more of a wireless transceiver, a satellite transceiver, or a radio transceiver.

The wireless network 302 can be provided by wireless access points implemented in the vehicle network 200. As the vehicles 102, 206 travel through different travel zones, a wireless network component of the communication device 116 onboard the vehicles 102, 206 can detect different wireless network access points provided by wayside devices 210 or other communication devices along the pathways 204 of the vehicle network 200. In one example, a single wireless network 302 covers a travel territory, and different wayside devices 210 provide access points to the wireless network 302. Non-limiting examples of protocols that wireless network devices follow to connect to the wireless network 302 include IEEE 802.11, Wi-Max, Wi-Fi, and the like. In one example, the wireless network communications operate around the 220 MHz frequency band. By relaying vehicle data communications through the wireless network 302, communications, including event alert communications, can be made more reliable, especially in conditions where direct radio communication can be lost.

The satellite network 304 utilized by the vehicle network 200 can be provided by one or more satellites. The vehicles 102, 206 can transmit and receive data communications relayed through one or more satellites via satellite transceivers implemented as part of the communication devices 116. In one example, a satellite transceiver can receive vehicle location information from a third-party global position system to determine the location of the respective vehicle 102, 206. The vehicles 102, 206 can communicate directly with each other via the satellite network 304 or the vehicles 102, 206 can communicate indirectly with each other through one or more offboard control systems 208 associated with the vehicle network 200.

The radio frequency (RF) network 306 utilized by the vehicle network 200 can be provided by one or more RF communications towers and RF repeaters. The vehicles 102, 206 can transmit and receive RF data communications relayed through one or more RF communications networks via radio transceivers onboard the vehicles 102, 206 implemented as part of the communication devices 116. In some embodiments, an RF transceiver includes a cellular radio transceiver (e.g., cellular telephone module) that enables a cellular communication path. In one example, the cellular radio transceiver communicates with cellular telephony towers located proximate to the pathways 204 of the vehicle network 200. For example, radio transceivers enables data communications between the vehicles 102, 206 directly through a third-party cellular provider. Additionally or alternatively, radio transceivers enable data communication between the vehicles 102, 206 and the one or more offboard control systems 208 through a third-party cellular provider.

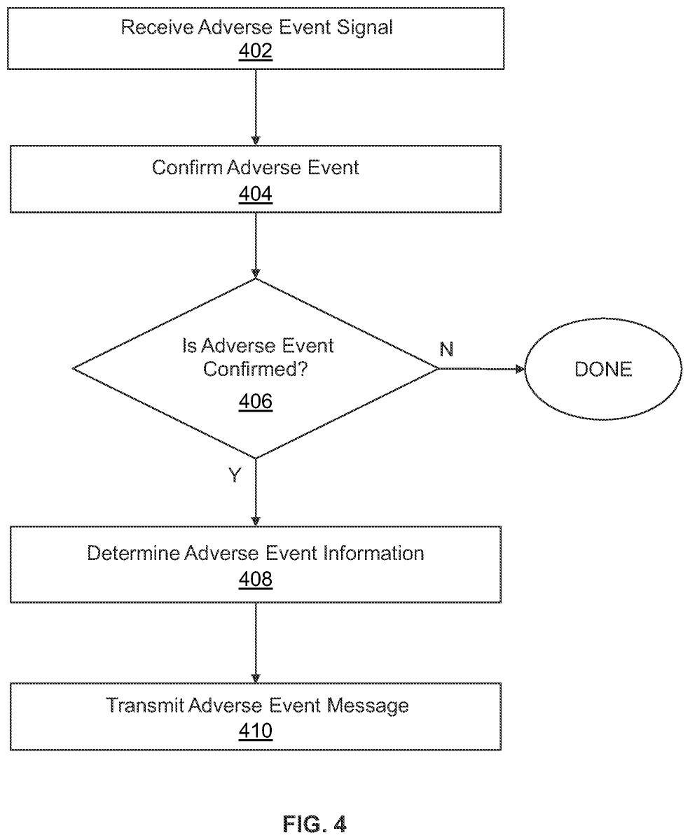

FIG. 4 illustrates an example process for managing an adverse event in accordance with one or more embodiments described herein. The operations of FIG. 4 may be carried out by the one or more processors 112 of the onboard controller 104 in response to execution of program instructions. Optionally, all or a portion of the operations of FIG. 4 may be carried out without program instructions, such as in an image signal processor associated with the optical sensor 114 that has the corresponding operations implemented in silicon gates and other hardware. It should be recognized that while the operations of method 400 are described in a somewhat serial manner, one or more of the operations of method 400 may be continuous and/or performed in parallel with one another. Furthermore, one or more of the operations may be performed in a different order than shown in FIG. 4, and/or an additional or different step may be performed as well as the steps described.

At step 402, the one or more processors 112 receive an event signal indicative of an adverse event 212. The event signal may be generated in response to a user-based instruction and/or may represent an output from one or more sensors, such as an optical sensor or a non-optical sensor. For example, the event signal can be generated in response to a user-based instruction received at a user interface device 110 operably coupled to the onboard controller 104. For example, the crew can access the user interface device 110 and execute a function to generate an event signal. Additionally or alternatively, the event signal can be generated based on a value of a sensed parameter of one or more sensors 108 and/or one or more optical sensors 114 operably coupled to the onboard controller 104. The event signal can represent one or more values of speed, position, orientation, vibration, pressure, humidity, or liquid level that meet predetermined criteria for an event signal or based on certain conditions present in image data (e.g., misalignment of benchmark features in the image data compared to benchmark image data).

Optionally, at steps 404 and 406, the one or more processors 112 confirm the adverse event 212. Confirmation of the adverse event 212 can take place before, after, or as part of determining event information associated with the adverse event 212. The one or more processors 112 may confirm the adverse event 212 based on generating a request for and receiving a confirmation signal initiated by one or more users at the user interface device 110. Additionally or alternatively, the one or more processors 112 can confirm the event by obtaining additional and/or different (e.g., in time or location) values of one or more sensed parameters that exceed a threshold value from the one or more sensors 108 and/or the one or more optical sensors 114. Examples of sensed parameter values for confirming an event signal can include one or more values that fall outside a select range, that fall below or exceed a threshold value, or that do not otherwise occur during normal operation of the first vehicle 102. For example, based on receiving an event signal generated by a crew at the onboard controller 104, the one or more processors 112 can confirm the event by obtaining acceleration values indicative of a sudden stop, orientation values/signatures of the vehicle 102 indicative of a non-operational orientation of the vehicle 102, and the like. Additionally or alternatively, the one or more processors 112 may confirm the adverse event 212 by obtaining one or more image attributes of interest present in the image data captured by the one or more optical sensors 114. For example, the one or more processors 112 can confirm the event by obtaining and examining image data, and by determining, based on benchmark features (e.g., tracks, a horizon, etc.) and/or images (e.g. images from the optical sensor in an operational orientation, etc.), whether certain conditions exist at the vehicle 102 as described above.

Based on the one or more processors 112 being unable to confirm the adverse event 212 or receiving confirmation that the event signal was generated in error, the one or more processors 112 interpret the event signal to not represent an adverse event and the process ends. Based on the one or more processors 112 confirming the adverse event 212, the one or more processors 112 interpret the adverse event 212 to have occurred and the process continues.

At step 408, the one or more processors 112 determine event information associated with the adverse event 212. The event information can include one or more of sensed parameter data output from one or more sensors 108, image data captured by one or more optical sensors 114. The event information may also include one or more of a vehicle identification, a vehicle location, or vehicle consist information. Additionally or alternatively, the event information can include a medical attention indicator indicative of a requested medical response (e.g., a number an extent of potentially injured crew and passengers, potential types of injuries such as chemical exposure and/or burns), a vehicle count indicator indicative of a number of vehicles associated with the event 212, or a hazardous condition indicator indicative of a requested hazardous condition response (e.g., notice that the vehicle 102 contains a hazardous substance). The event information optionally may include a type or category of the adverse event 212.

At step 410, the one or more processors 112 generate an event alert that includes the event information, and communicate the event alert to other parties. The other parties to which the event alert is communicated may include one or more other vehicles 206 operating in a designated range of the vehicle 102 and/or the location of the adverse event 212, and/or which are scheduled to pass within the designated range of the adverse event 212 within a designated amount of time from the time that the event alert was generated. The first vehicle 102 may also communicate the event alert to one or more offboard control systems 208 that control movement of at least the vehicle 102 originating the event alert and the one or more other vehicles 206 in the vehicle network 200. In one example, the event alert may be directly communicated from the first vehicle 102 to a corresponding onboard controller of the one or more other vehicles 206. In an embodiment, the event alert may include a re-route message and/or a control command message that automatically modifies the movement of the recipient vehicle 206 to bypass the adverse event 212. Based on receiving the event alert, the corresponding onboard controllers can implement the instructions (e.g., navigation details, steering settings, tractive and brake settings, etc.) contained in the event alert to avoid the area of the event 212. Additionally or alternatively, the event alert may be indirectly communicated from the vehicle 102 to the one or more other vehicles 206 via the one or more offboard control systems 208. The event alert may be one or more of relayed to the one or more other vehicles 206 and or emergency response services automatically (e.g., without dispatcher action). Optionally, the event alert may be concurrently relayed to a dispatcher for manual assessment of the severity of the adverse event 212 and further action based thereon. For example, the dispatcher can attempt to contact the crew and/or alert emergency response services based on the type and extent of the adverse event 212, but the onboard controller 104 does not wait for the dispatcher before sending the event alert to other vehicles 206 or the offboard control system 208. Accordingly, adverse events 212 are reported in a manner that reduces the risk presented by the adverse event 212 to other vehicles 206 in the vehicle network 200 and improves the response to the adverse event 212 itself by indicating the types of and extent of emergency responses needed.

In an example, a vehicle control system includes an onboard controller disposed onboard a first vehicle. The onboard controller may receive an event signal indicative of an adverse event on a vehicular pathway. The event signal may be received from one or more of a user interface device or one or more sensors disposed onboard the first vehicle. The onboard controller may determine event information associated with the adverse event on the vehicular pathway and the first vehicle, and generate an event alert that contains the event information. The onboard controller may control a communication device onboard the first vehicle to communicate the event alert to an offboard control system configured to control movement of one or more second vehicles based on the event alert by modifying a respective planned route of each of the one or more second vehicles to bypass a location of the adverse event. The one or more second vehicles are not mechanically connected to the first vehicle and do not operate under control of the first vehicle.

Optionally, the onboard controller may determine, as part of the event information, a type of the adverse event based on one or more of (i) sensed parameter data output from the one or more sensors; (ii) analysis of image data generated by one or more optical sensors disposed onboard the first vehicle; or (iii) user input via the user interface device. The event information may include one or more of a medical attention indicator indicative of a requested medical response, a vehicle count indicator indicative of a number of vehicles associated with the event, a hazardous condition indicator indicative of a requested hazardous condition response, or an identification of the first vehicle. The onboard controller may select a first responder based on the type of the adverse event, and may control the communication device to also communicate the event alert to the first responder that is selected. The onboard controller may communicate the event alert to (i) medical emergency first responders in response to determining that the type of the adverse event is one of a rollover accident, a derailment, or a collision between multiple vehicles; (ii) a roadside vehicle maintenance crew in response to determining that the type of the adverse event is a stalled vehicle; and (iii) a route maintenance crew in response to determining that the type of the adverse event is an obstacle blocking the vehicular pathway.

Optionally, the onboard controller may separately communicate the event alert to the one or more second vehicles. The first vehicle is in a vehicle network with other vehicles. The onboard controller may obtain planned routes of the other vehicles in the vehicle network. The onboard controller may identify the one or more second vehicles to which to communicate the event alert, from the other vehicles in the vehicle network, based on a comparison of the location of the adverse event to the planned routes.

The vehicle control system may include the offboard control system, which may modify the respective planned route of each of the one or more second vehicles by generating and transmitting respective re-route messages to the one or more second vehicles. Each of the re-route messages may include detour navigation details that alter a series of pathways according to the planned route of the corresponding second vehicle that receives the re-route message to cause the corresponding second vehicle to bypass the location of the adverse event. Alternatively, the offboard control system may modify the respective planned route of each of the one or more second vehicles by generating and transmitting respective control command messages to the one or more second vehicles. Each of the control command messages may include one or more of steering settings, tractive settings, or brake settings that are automatically implemented by the corresponding second vehicle that receives the control command message to cause the corresponding second vehicle to bypass the location of the adverse event. Optionally, the offboard control system may identify the one or more second vehicles to which to modify the respective planned route thereof by determining that the one or more second vehicles are scheduled to travel through or within a designated proximity of the location of the adverse event within a designated period of time of receiving the event alert. Optionally, the offboard control system may modify the respective planned route of each of the one or more second vehicles to cause the one or more second vehicles to bypass the location of the adverse event and avoid one or more pathways expected to be traversed by first responder vehicles traveling to the location of the adverse event.

The onboard controller may confirm the adverse event after receiving the event signal and prior to generating the event alert. The onboard controller may confirm the adverse event by receiving a confirmation signal generated by the user interface device upon receiving an operator input. The onboard controller may confirm the adverse event by obtaining a value of a sensed parameter output by the one or more sensors that exceeds a threshold value. The onboard controller may confirm the adverse event by obtaining one or more image attributes of interest present in the image data generated by the one or more optical sensors. Optionally, in response to the onboard controller receiving the event signal from the user interface device based on an operator input, the onboard controller may confirm the adverse event by obtaining a value of a sensed parameter output by the one or more sensors that exceeds a threshold value.

In an example, a method for managing adverse events includes receiving, via an onboard controller disposed onboard a first vehicle, an event signal indicative of an adverse event on a vehicular pathway. The event signal may be received from one or more of a user interface device or one or more sensors disposed onboard the first vehicle. The method may include determining event information associated with the adverse event on the vehicular pathway and the first vehicle, and generating an event alert that contains the event information. The method may include controlling a communication device onboard the first vehicle to communicate the event alert to an offboard control system configured to control movement of one or more second vehicles based on the event alert by modifying a respective planned route of each of the one or more second vehicles to bypass a location of the adverse event. The one or more second vehicles are not mechanically connected to the first vehicle and do not operate under control of the first vehicle.

Optionally, the method includes determining, as part of the event information, a type of the adverse event based on one or more of (i) sensed parameter data output from the one or more sensors; (ii) analysis of image data generated by one or more optical sensors disposed onboard the first vehicle; or (iii) user input via the user interface device. The method may include selecting a first responder based on the type of the adverse event, and controlling the communication device to also communicate the event alert to the first responder that is selected. The method may include obtaining planned routes of other vehicles in a vehicle network, and identifying the one or more second vehicles to which to communicate the event alert, from the other vehicles in the vehicle network, based on a comparison of the location of the adverse event to the planned routes.

In an example, a vehicle control system includes an onboard controller disposed onboard a first vehicle. The onboard controller may receive an event signal indicative of an adverse event on a vehicular pathway. The event signal may be received from one or more of a user interface device or one or more sensors disposed onboard the first vehicle. The onboard controller may obtain planned routes of other vehicles in a vehicle network with the first vehicle, and may determine one or more second vehicles of the other vehicles in the vehicle network that are affected by the adverse event based on a comparison between a location of the adverse event and the planned routes of the other vehicles, prior to the one or more second vehicles reaching the location of the adverse event. The one or more second vehicles are not mechanically connected to the first vehicle and do not operate under control of the first vehicle. The onboard controller may generate a respective event alert for each of the one or more second vehicles that are determined. The onboard controller may generate each respective event alert to include at least one of a re-route message or a control command message to modify the respective planned route of the corresponding second vehicle to cause the corresponding second vehicle to bypass the location of the adverse event. The onboard controller may control a communication device onboard the first vehicle to communicate the event alerts to the one or more second vehicles.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A or B” (where “A” and “B” represent claim elements), are used to encompass i) A, ii) B and/or iii) both A and B. For the avoidance of doubt, the claim limitation “the event information further comprises one or more of a medical attention indicator indicative of a requested medical response, a vehicle count indicator indicative of a number of vehicles associated with the event, or a hazardous condition indicator indicative of a requested hazardous condition response” means and shall encompass “i) the event information further comprises a medical attention indicator indicative of a requested medical response”, “ii) the event information further comprises a vehicle count indicator indicative of a number of vehicles associated with the event”, “iii) the event information further comprises a hazardous condition indicator indicative of a requested hazardous condition response”, “iv) the event information further comprises a medical attention indicator indicative of a requested medical response and a vehicle count indicator indicative of a number of vehicles associated with the event”, “v) the event information further comprises a vehicle count indicator indicative of a number of vehicles associated with the event and a hazardous condition indicator indicative of a requested hazardous condition response”, “vi) the event information further comprises a medical attention indicator indicative of a requested medical response and a hazardous condition indicator indicative of a requested hazardous condition response”, and/or “vii) the event information further comprises a medical attention indicator indicative of a requested medical response, a vehicle count indicator indicative of a number of vehicles associated with the event, and a hazardous condition indicator indicative of a requested hazardous condition response”.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A vehicle control system comprising:
an onboard controller disposed onboard a first vehicle, the onboard controller configured to:
receive an event signal indicative of an adverse event on a vehicular pathway, the event signal received from one or more of a user interface device or one or more sensors disposed onboard the first vehicle;
determine event information associated with the adverse event on the vehicular pathway and the first vehicle;
generate an event alert that contains the event information; and
control a communication device onboard the first vehicle to communicate the event alert to an offboard control system configured to control movement of one or more second vehicles based on the event alert by modifying a respective planned route of each of the one or more second vehicles to bypass a location of the adverse event, wherein the one or more second vehicles are not mechanically connected to the first vehicle and do not operate under control of the first vehicle.

2. The vehicle control system of claim 1, wherein the onboard controller is configured to determine, as part of the event information, a type of the adverse event based on one or more of (i) sensed parameter data output from the one or more sensors; (ii) analysis of image data generated by one or more optical sensors disposed onboard the first vehicle; or (iii) user input via the user interface device.

3. The vehicle control system of claim 2, wherein the onboard controller is configured select a first responder based on the type of the adverse event, and to control the communication device to also communicate the event alert to the first responder that is selected.

4. The vehicle control system of claim 3, wherein the onboard controller is configured to communicate the event alert to:
medical emergency first responders in response to determining that the type of the adverse event is one of a rollover accident, a derailment, or a collision between multiple vehicles;
a roadside vehicle maintenance crew in response to determining that the type of the adverse event is a stalled vehicle; and
a route maintenance crew in response to determining that the type of the adverse event is an obstacle blocking the vehicular pathway.

5. The vehicle control system of claim 1, wherein the onboard controller is configured to separately communicate the event alert to the one or more second vehicles.

6. The vehicle control system of claim 5, wherein the first vehicle is in a vehicle network with other vehicles, the onboard controller configured to obtain planned routes of the other vehicles in the vehicle network, wherein the onboard controller is configured to identify the one or more second vehicles to which to communicate the event alert, from the other vehicles in the vehicle network, based on a comparison of the location of the adverse event to the planned routes.

7. The vehicle control system of claim 1, further comprising the offboard control system, wherein the offboard control system is configured to modify the respective planned route of each of the one or more second vehicles by generating and transmitting respective re-route messages to the one or more second vehicles, each of the re-route messages including detour navigation details that alter a series of pathways according to the planned route of the corresponding second vehicle that receives the re-route message to cause the corresponding second vehicle to bypass the location of the adverse event.

8. The vehicle control system of claim 1, further comprising the offboard control system, wherein the offboard control system is configured to modify the respective planned route of each of the one or more second vehicles by generating and transmitting respective control command messages to the one or more second vehicles, each of the control command messages including one or more of steering settings, tractive settings, or brake settings that are automatically implemented by the corresponding second vehicle that receives the control command message to cause the corresponding second vehicle to bypass the location of the adverse event.

9. The vehicle control system of claim 1, further comprising the offboard control system, wherein the offboard control system is configured to identify the one or more second vehicles to which to modify the respective planned route thereof by determining that the one or more second vehicles are scheduled to travel through or within a designated proximity of the location of the adverse event within a designated period of time of receiving the event alert.

10. The vehicle control system of claim 1, further comprising the offboard control system, wherein the offboard control system is configured to modify the respective planned route of each of the one or more second vehicles to cause the one or more second vehicles to bypass the location of the adverse event and avoid one or more pathways expected to be traversed by first responder vehicles traveling to the location of the adverse event.

11. The vehicle control system of claim 1, wherein the onboard controller is further configured to confirm the adverse event after receiving the event signal and prior to generating the event alert, wherein the onboard controller is configured to confirm the adverse event by receiving a confirmation signal generated by the user interface device upon receiving an operator input.

12. The vehicle control system of claim 1, wherein the onboard controller is further configured to confirm the adverse event after receiving the event signal and prior to generating the event alert, wherein the onboard controller is configured to confirm the adverse event by obtaining a value of a sensed parameter output by the one or more sensors that exceeds a threshold value.

13. The vehicle control system of claim 1, wherein the onboard controller is further configured to confirm the adverse event after receiving the event signal and prior to generating the event alert, wherein the onboard controller is configured to confirm the adverse event by obtaining one or more image attributes of interest present in the image data generated by the one or more optical sensors.

14. The vehicle control system of claim 1, wherein, in response to the onboard controller receiving the event signal from the user interface device based on an operator input, the onboard controller is configured to confirm the adverse event by obtaining a value of a sensed parameter output by the one or more sensors that exceeds a threshold value.

15. The vehicle control system of claim 1, wherein the event information further comprises one or more of a medical attention indicator indicative of a requested medical response, a vehicle count indicator indicative of a number of vehicles associated with the event, a hazardous condition indicator indicative of a requested hazardous condition response, or an identification of the first vehicle.

16. A method for managing adverse events, the method comprising:
receiving, via an onboard controller disposed onboard a first vehicle, an event signal indicative of an adverse event on a vehicular pathway, the event signal received from one or more of a user interface device or one or more sensors disposed onboard the first vehicle;
determining event information associated with the adverse event on the vehicular pathway and the first vehicle;
generating an event alert that contains the event information; and
controlling a communication device onboard the first vehicle to communicate the event alert to an offboard control system configured to control movement of one or more second vehicles based on the event alert by modifying a respective planned route of each of the one or more second vehicles to bypass a location of the adverse event, wherein the one or more second vehicles are not mechanically connected to the first vehicle and do not operate under control of the first vehicle.

17. The method of claim 16, further comprising determining, as part of the event information, a type of the adverse event based on one or more of (i) sensed parameter data output from the one or more sensors; (ii) analysis of image data generated by one or more optical sensors disposed onboard the first vehicle; or (iii) user input via the user interface device.

18. The method of claim 17, further comprising:
selecting a first responder based on the type of the adverse event; and
controlling the communication device to also communicate the event alert to the first responder that is selected.

19. The method of claim 16, further comprising:
obtaining planned routes of other vehicles in a vehicle network; and
identifying the one or more second vehicles to which to communicate the event alert, from the other vehicles in the vehicle network, based on a comparison of the location of the adverse event to the planned routes.

20. A vehicle control system comprising:
an onboard controller disposed onboard a first vehicle, the onboard controller configured to:
receive an event signal indicative of an adverse event on a vehicular pathway, the event signal received from one or more of a user interface device or one or more sensors disposed onboard the first vehicle;
obtain planned routes of other vehicles in a vehicle network with the first vehicle;
determine one or more second vehicles of the other vehicles in the vehicle network that are affected by the adverse event based on a comparison between a location of the adverse event and the planned routes of the other vehicles, prior to the one or more second vehicles reaching the location of the adverse event, wherein the one or more second vehicles are not mechanically connected to the first vehicle and do not operate under control of the first vehicle;
generate a respective event alert for each of the one or more second vehicles that are determined, the onboard controller configured to generate each respective event alert to include at least one of a re-route message or a control command message to modify the respective planned route of the corresponding second vehicle to cause the corresponding second vehicle to bypass the location of the adverse event; and
control a communication device onboard the first vehicle to communicate the event alerts to the one or more second vehicles.
